(19) United States
(12) Patent Application Publication
(10) Pub. No.: US 2009/0119290 A1
(43) Pub. Date: May 7, 2009

(54) ON-LINE E-MAIL SERVICE SYSTEM, AND SERVICE METHOD THEREOF

(75) Inventor: Woo Ju Lee, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: NHN Corporation, Gyeonggi-do (KR)

(21) Appl. No.: 12/346,325

(22) Filed: Dec. 30, 2008

Related U.S. Application Data
(63) Continuation of application No. PCT/KR2007/003171, filed on Jun. 29, 2007.

(30) Foreign Application Priority Data
Jun. 30, 2006 (KR) 10-2006-0060108

(51) Int. Cl. G06F 17/30; G06F 15/16

(52) U.S. Cl. 707/5; 709/206; 707/E17.014; 707/E17.032

(57) ABSTRACT

Embodiments of the present disclosure provide a method and system in which contextual information is obtained and inserted into the body of the e-mail. Users may authorize the access and analysis of the contents of their e-mails. Upon recognizing transmission of an email from one of the users, the content of the e-mail is analyzed to determine a topic or uncommon concept. The topic or uncommon concept of the email may be determined, for example, by analyzing the relative popularity or frequency of use of terms used in the e-mail. Information relevant to the e-mail's topic and content is then obtained by searching various sources, such as one or more databases, search servers, or the Internet. The relevant information may be inserted or otherwise included in the body of a reply e-mail or other related e-mail. The relevant information may be inserted in various forms, such as a hyperlink, or other formatted text. An e-mail may also be delivered to the sender to notify the sender of the information included in the reply e-mail. Furthermore, the e-mail and the relevant information may be translated into one or more languages depending on the preference of the sender or the receiver.

### CROSS REFERENCE TO RELATED APPLICATIONS

This application is a continuation of PCT International Application Number PCT/KR2007/003171, filed on Jun. 29, 2007, designating the United States of America and published in the English language, which claims priority under 35 U.S.C. § 119 to Korean Application Number 10-2006-0060108 filed on Jun. 30, 2006. The disclosures of the above-referenced applications are hereby expressly incorporated by reference in their entireties.

### BACKGROUND

1. Field

The present invention disclosure relates to an online e-mail system and method thereof, particularly, to a system and method for providing an e-mail communications tool which can simply and conveniently provide detailed information relating to a specific term, when a detailed knowledge relating to the term is required among the content of the mail in case of receiving an e-mail online.

2. Related Technology

Recently, conventional mail handled by the postal service has decreased. Most of normal communications or informational communications relating to daily life or a task is now performed by e-mail. E-mail is provided through a mail transmission/receive service of a specific server in which a plurality of clients is subscribed. As to a general e-mail service system, a web server receiving the external mail on-line transmits the mail which is received to a client that is registered in the e-mail service. In that way, the mail which is received is confirmed in the mail web window of each client.

However, in the content of the mail, frequently, detailed information on a particular portion of the content is required. For example, a query for information may be required, or an unfamiliar term is included in the content of the mail, as well as the content that the sender inquires after the receiver is included in the content of the mail. Conventionally, the information is later searched and obtained by the recipient or sender by connecting to another server, which is not the mail web server, or the detailed information is obtained by an additional method.

In case that the information is acquired by connecting to another server, which is not mail server, there is a problem that a somewhat complicated process must be performed and much time may be spent. Additionally, it is inconvenient in that the detailed information must be additionally collected and a file must be attached in order to deliver the content of the detailed information to the person who sent the mail asking for the specific information in the content of the received mail with a reply.

### SUMMARY

A feature of the present disclosure is to solve at least the problems and disadvantages of the related art. The present disclosure provides a system and method including the e-mail communications tool providing a system and method for obtaining, easily and rapidly, the detailed information relating to the mail contents, capable of returning, easily and rapidly, the content of the detailed information which is queried on the mail to an inquirer, in communicating an online mail.

According to an aspect of the present disclosure, an online mail service system is provided and comprises a mail server that receives a mail, and stores the mail; a data server that stores a plurality of detailed information; a search server that searches a keyword among the content of the stored mail by analyzing a morpheme; and a matching server that matches the detail information of the data server with the keyword which is searched in the search server, wherein the matched one or more pieces of detailed information are displayed on a part of the area of a mail web window of a client.

Preferably, the data server may include the keyword and stores a data which is formed through the reply of one or more clients for a query when the query is made by at least one client in an online, and the search server translates a term classified by a morpheme among the content of the stored mail into a language which is selected by the client receiving the mail. Further, it may be preferable that the search server searches a term by assigning a rank from the term having a lowest use frequency among the mail contents that the multiple clients of the mail service use, and the search server includes a search data server that stores a real-time popularity search ranking information data which a plurality of online clients search; and performs searching in the order of the real-time search ranking stored in the search data server. Additionally, it may be preferable that the search server performs searching by directly inputting through a search window formed in a part of the area of the mail web window of the client receiving the mail, and the search server translates the keyword which the client inputted into the language which the client receiving the mail selected. Furthermore, it may be preferable that, in case the client receiving the mail transmits a reply mail, the matched one or more pieces of detailed information are automatically inserted or attached to the reply mail content.

According to another aspect of the present invention, a method of internet online mail service is provided, which comprises the steps of: analyzing a morpheme among the mail contents received in a mail server to select a keyword; matching a detail information data of a data server in which a plurality of information are stored with the selected keyword; and displaying the matched one or more pieces of detailed information on a part of the area of a mail web window of a client.

Preferably, the data server can include a keyword, while the data server includes the keyword; and stores a data which is formed through the reply of one or more clients for a query, while the query is made by at least one client in an online. Further, it may be preferable that the data server includes a keyword, while the data server includes the keyword; and stores a data which is formed through the reply of one or more clients for a query, while the query is made by at least one client in an online.

It may be preferable that, in selecting a keyword, a term classified by a morpheme among the content of the stored mail is translated into a language which is selected by the client receiving the mail. In selecting a keyword, a rank is assigned for a term from the term having a lowest use frequency among the mail contents that the multiple clients of the mail service use.

It may be preferable that, in selecting a keyword, the selecting is performed in the order of a real-time search ranking stored in a search data server, wherein the search data server stores a real-time popularity search ranking information data which a plurality of online clients search. In selecting a keyword, the selecting can be performed by directly inputting through the search window formed in a part of the area of the mail web window of the client receiving the mail.

It may also be preferable that, selecting a keyword includes translating into a language which the client selected, in case the client selects a term which is different from the term classified by a morpheme among the content of the stored mail. It is preferable that, in case the client receiving the mail transmits a reply mail, the matched one or more pieces of detailed information are automatically inserted or attached to the reply mail content.

According to a further aspect of the present disclosure, a recording medium is provided, which is readable in a computer, recording a program for executing the method of another aspect of the present invention.

According to the present disclosure, the e-mail receiver is capable of easily and rapidly obtaining detailed information relating to the mail contents as well as easily and rapidly returning the content of the detailed information queried on the mail to an inquirer.

### BRIEF DESCRIPTION OF THE DRAWINGS

FIG. 1 is a drawing showing a block diagram of an online e-mail service system according to the present disclosure.

FIGS. 2-4 are exemplary drawings showing a mail web window of a client which is shown through an online e-mail service system according to the present disclosure.

FIG. 5 is an example of the online email system according to the present disclosure, showing a mail web window of a client including a mail content of foreign language except the native language.

FIG. 6 is an embodiment of the present disclosure, and is a drawing showing a flowchart of the method for searching a keyword in a search server which is an element of the online email system.

FIG. 7 is another embodiment of the present disclosure, and is an exemplary drawing showing the configuration of the search server which extracts a keyword in the order of the real-time popularity search which is an element of online e-mail service system according to the present disclosure.

FIG. 8 is an embodiment of a second feature according to the present disclosure, and is an exemplary diagram showing the mail web window of a client applying the online email system.

FIG. 9 is further embodiment of the present disclosure, and is an exemplary diagram showing the mail web window which is provided to e-mail transmitter in case the client that received the mail returns the reply mail.

FIG. 10 is a drawing showing a flowchart of the online service method according to the present disclosure.

FIGS. 11 and 12 are the drawing exemplifying a logical flow chart of the query and reply system as data server used in the online e-mail service method according to the present disclosure.

FIG. 13 is a further embodiment according to the present disclosure, is a drawing showing a flowchart of the method which is applied in case detailed information is acquired in a language, which is different from the other language of the mail contents received in the keyword selection step.

Hereinafter, referring to the drawings, the embodiments according to the present disclosure will be illustrated in detail.

### DETAILED DESCRIPTION

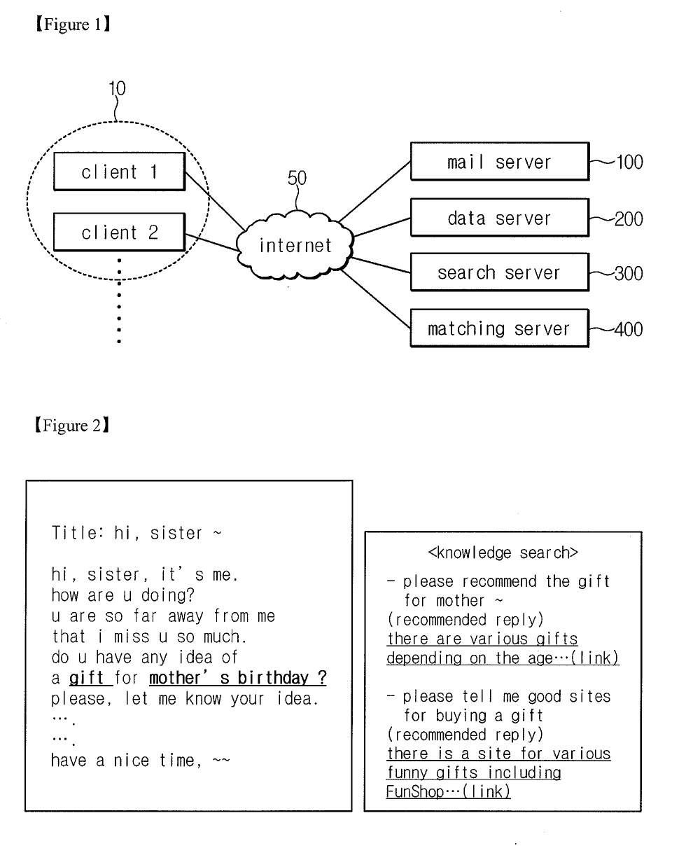

FIG. 1 is a drawing showing a block diagram of an online e-mail service system according to the present disclosure.

As shown in FIG. 1, the e-mail service system has a basic structure that each client 10, which is registered online to the mail service, is connected to Internet 50 while receiving the mail service through Internet 50. As to the structure of the general mail service, in case the mail is transmitted from the outside or the registered client 10, the mail server 100 receives and stores the mail, while the stored mail is confirmed through the mail web window of each client 10 provided from the mail server.

On the other hand, the present disclosure provides a mail server 100 which stores and receives a mail, a data server 200 in which a plurality of detailed information are stored, a search server 300 which analyzes the morpheme of the stored e-mail content and searches a keyword, and a matching server 400 which matches the detail information data of the data server with the keyword which is searched in the search server. Additionally, one or more pieces of detailed information which are matched like this are displayed in a part of the region of the mail web window of the client 10.

Here, at least one among a plurality of the stored data servers 200, the search server which analyzes the morpheme of the stored e-mail content and searches a keyword, and the matching server 400 which matches the detail information data of the data server with the keyword which is searched in the search server can be installed in the outside which is not the online mail service system according to the present invention.

That is, a keyword can be extracted through the outside search server to provide to the mail server, while detail information data can be provided through the outside data server. Additionally, it is possible to match the keyword with the detail information data through the outside matching server. It is preferable that the data server 200 which is an element of the online email system stores knowledge data which is composed of the query and reply through the online network.

That is, a user questioner having a query is connected with a query and reply service system through the internet to register his own query by using his own user terminal. Further, other user answerer is connected with the query and reply service system through the internet to register his own reply to the query by using his own user terminal.

By using such configuration, the query and reply can be performed among users on the internet, and the questioner can obtain the reply to his own query. Moreover, the query and reply service system stores a query and a reply to the query in a data server by including a given database to provide the online e-mail service system according to the invention.

FIG. 2 to FIG. 4 show exemplary drawings showing a mail web window of a client which is shown through an online e-mail service system according to the present disclosure.

As shown in FIG. 2, when a client confirms the mail, the morpheme of the mail contents is analyzed and a keyword is searched and extracted. The detailed information related with the extracted keyword is disclosed in a part of an area of the client mail web window.

As shown in FIG. 2, the term such as mother, birthday, gift, among the content of the mail, is extracted from the search server, and the extracted term is matched with the detailed information of the data server, thereafter, the matched detailed information is displayed in a part of the area of the client mail web window. Accordingly, an e-mail communications tool can be provided to the e-mail service user.

The keyword extracting method at the search server 300 described above can be variously applied. However, the method that extracts a keyword according to the use frequency of the term which is used in writing a mail by a general user of the mail service is desirable. Additionally, the method that extracts a keyword correspondingly to the ranking of real-time popularity search made by the online internet users is also desirable.

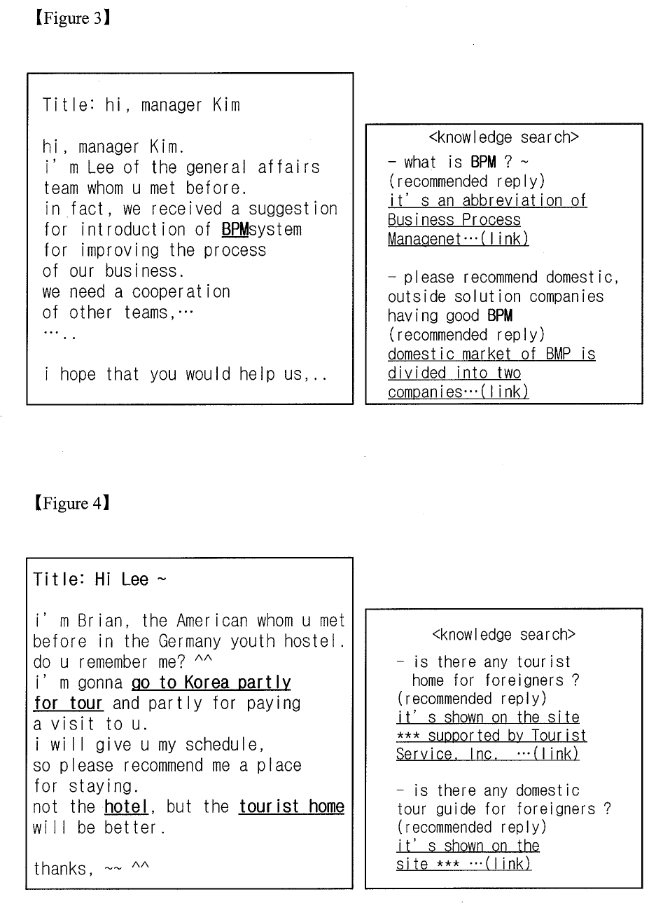

That is, in case the term to be searched is a term which is not so frequently used by the general mail service user like BPM which is one term among the mail contents of FIG. 3, the use frequency of the term is low, while the morpheme is classified and extracted in the order of term having a low use frequency. Therefore, some embodiments of the invention have an advantage that it substantially meets the demand of the service user, in that the client specially requires, in general, the detailed information for a term which is unacquainted. Additionally, in the terms such as sightseeing, home-stay, etc of FIG. 4, a keyword is extracted in the order of the term having a low use frequency. Therefore, some embodiments of the invention have an advantage that it easily can obtain the detailed information which is suitable for the query of the mail sender among the mail contents.

Here, as shown in FIG. 2 to FIG. 4, the keyword extracted by the search server can be distinguished from other terms by using a specific font including a bold font, or by underscoring, and the information relating to the term can be automatically displayed in a part of the area of the client web window. In addition, it is possible to display the term which is a keyword extracted among the mail contents on a part of the area of the client mail web window by directly clicking the term of the specific font like the bold font or the term which is underscored. Further, preferably, the detailed information displayed on a part of the area of the client mail web window displays the detailed information relating to the keyword, furthermore, it is displayed with linking the address in order to be able to connect to the site relating to the detailed information.

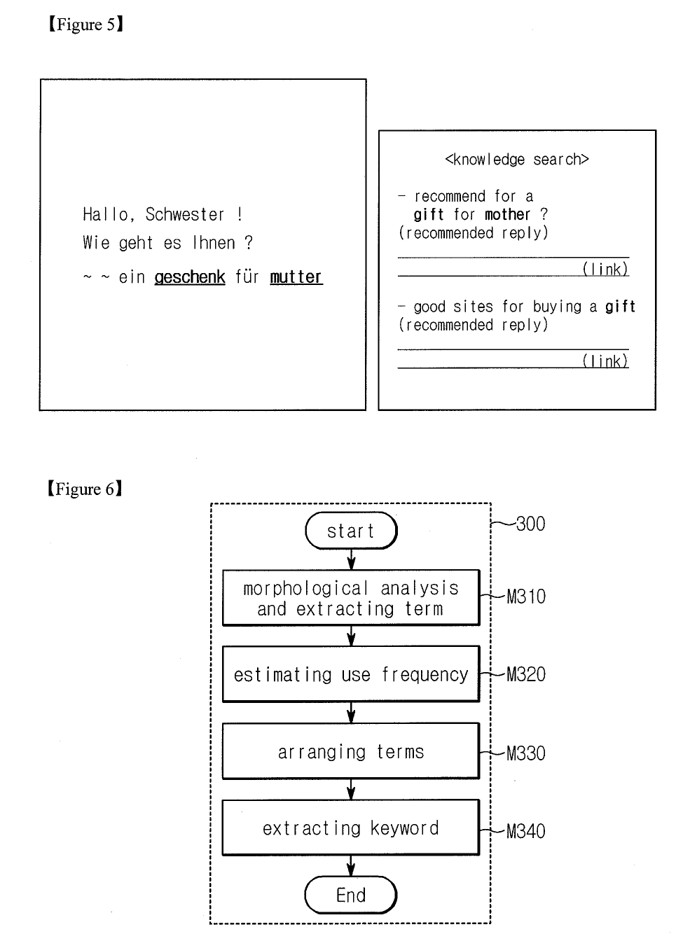

FIG. 5 shows an example of the online email system according to the present disclosure, showing a mail web window of a client including a mail in foreign language.

As shown in FIG. 5, a mail with other language which is not written by the native language can be received. Particularly, the foreign language mail except the native language relating to the normal company task can be occasionally received. In this way, in case of the mail of other language which is not the native language mail, when the mail service user searches the detailed information of the content of the mail, mostly, the detailed information is obtained through the outside search browser after translating the mail of other language into the native language.

On the other hand, some embodiments of the disclosure provides the online email system in which a keyword among the content of the mail stored in the mail server is extracted and translated into the native language through a translation server. The translated keyword is matched with the detailed information of data server to display the detailed information on a part of the area of the client mail web window.

As shown in FIG. 5, the detailed information related to the keyword is displayed in the right window for the keyword which is written in the bold font, thereby, it is easy for the mail user to acquire the corresponding detailed information. Further, the detailed information can be easily obtained by linking the site address relating to the keyword.

Even in case of receiving the mail in languages including Japanese, Chinese as well as Korean mail, the e-mail communications tool which passes through the translation process by the translation server included in the search server can be provided. The search server can include an additional translation server, however, it can be a server having the function of translating in the search server itself.

FIG. 6 is an embodiment of the present disclosure, and showing a flowchart of the method for searching a keyword in a search server 300 which is an element of the online email system.

As shown in FIG. 6, when a mail is received, the content which is composed of a sentence is disclosed. The sentence can comprise the morpheme of a noun, a pronoun, an adverb, and an adjective. As to the sentence of the mail content, firstly, a term is extracted through the morphological analysis M310. The extracted term is compared with the term that a plurality of clients or internet users use to estimate the use frequency of the term M320, and arranged in the order of the low frequency M330 to extract a keyword M340.

When the method for extracting or searching a keyword in the order of low frequency by estimating the frequency is applied, the term to be searched is unfamiliar to clients. Therefore, there is a high possibility of meeting the demand of the mail service user since it is probable that the detailed information is much more required.

Here, the reference point of the use frequency can be applied with the mail contents of the user of the mail service, or can be applied based on the mail contents that internet users usually use. It is preferable that the reference point of the use frequency is applied through statistics of much more e-mail users in order to sufficiently meet the demand of the e-mail service user. Moreover, it is more preferable that this reference point is not fixed, but it is diversified according to the usage pattern of the e-mail user. In this way, it can sufficiently meet the demand of the online e-mail service user.

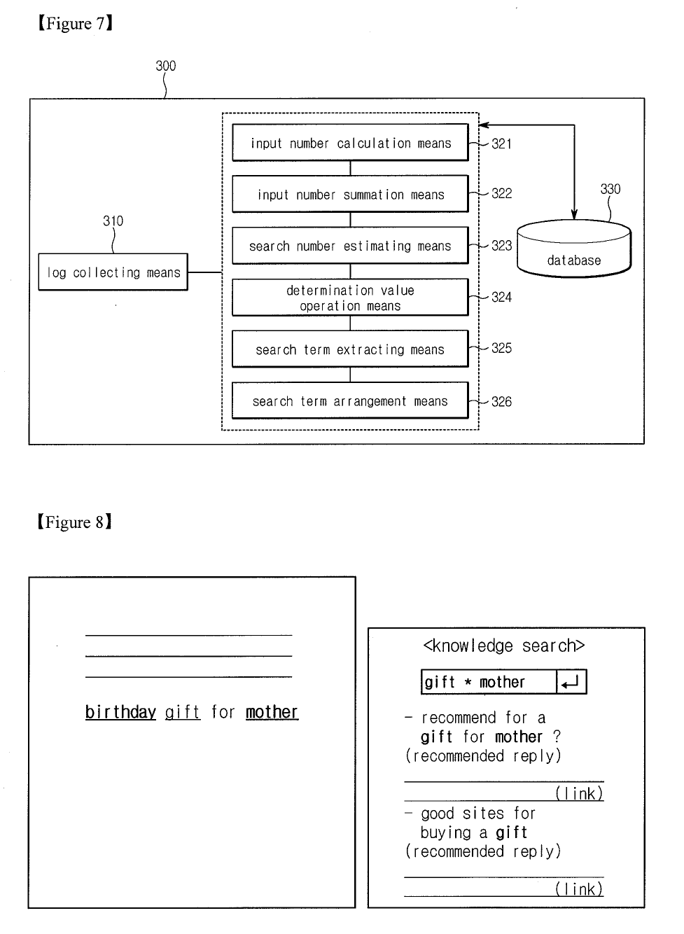

FIG. 7 is another embodiment of the present disclosure, and is an exemplary drawing showing the configuration of the search server which extracts a keyword in the order of the real-time popularity search which is an element of online e-mail service system according to the present disclosure.

A real-time popularity search term extraction search server 300 provides a log collecting means 310, an input number calculation means 321, an input number summation means 322, an search number estimating means 323, a determination value operation means 324, a search term extracting means 325 and a search term arrangement means 326.

The log collecting means 310 collects a log data from one or more outside search servers with a predetermined time interval. Here, the time interval can be a predetermined period which is flexibly set by the administrator of the real-time popularity search term extraction search server 300, for example, it can be set up for shorter periods as possible in order to more accurately detect a popularity search term which is a rapidly increased search term. That is, the log collecting means 310 confirms the present situation of the search term newly inputted to each search server of the inside during a period which is set up as the time interval through collected log data.

As described above, in the log data, the information on the search term inputted from the user terminal and the input time of the search term are included. For example, the log collecting means 310 that set the time interval as five seconds can obtain the information on the search term newly recorded in each search server in the past five seconds from the present based on the input time of the log data. The input number calculation means 321, computes the input number of the search term by using the collected log data, and relates the calculated input number of the search term with each time data to store in a database 330. That is, the input number calculation means 321 distinguishes the recorded search term which is newly inputted during the time interval through the log data, and counts the number of the input which is made based on the distinguished search term.

Moreover, the input number calculation means 321 can generate a time data relating to the time for collecting log data, and makes the generated time data and the input number of search term to correspond with each other and store them in the database 330. Accordingly, in the database 330, the information on the search term which is previously inputted before the present time point from the user terminal and the present input situation of search term is classified by the time interval to be continuously accumulated and stored.

The input number summation means 322 distinguishes one or more time data belonging to a predetermined sliding window with reference to the database 330, and adding up the input number of search term related to the distinguished time data according to each search term. Here, the sliding window means a virtual time range which plays the role of determining the information to be searched in the database 330, and can selectively search the information stored in the database 330 for a certain number of n periods which is set by the system administrator.

The search number estimating means 323 calculates the estimated search number of each search term based on the total input number. That is, the search number estimating means 323 plays the role of predicting the input number which is expected to be generated in the future time point based on the input number of search term calculated in the restricted time range close to the present time point. As to the calculation of the estimated search number, the search number estimating means 323 can predict the search number by using only the search term which is inputted just only for search, after excluding the search term which is artificially manipulated.

For example, in case an advertisement business carrier excessively inputs a specific search term under the intention of increasing the input number, the search number estimating means 323 determines the corresponding search term as an aggression search term and performs a predetermined exclusion processing so that the related input number may not be reflected to the calculation of the estimated search number. The reference time that estimates the estimated search number can be flexibly set by the system administrator, for example, the estimated search number can be estimated based on one day.

The determination value operation means 324 plays a role of calculating a first to a fourth determination value by using the estimated search number which is calculated. In addition, the search term extracting means 325 plays a role of detecting the real-time popularity search term based on the first to the fourth determination values which are calculated. Here, the determination value is numeric information which determines whether the relating search term is a popularity search term or not. The search term extracting means 325 determines the search term that has a determination value which is a fixed value or more or which is relatively greater as a popularity search term to detect.

Thereafter, the search term extracting means 325 compares the estimated search number with the first determination value by each search term, and detects the search term which has an estimated search number that is a first determination value or more. Additionally, the real-time popularity search term extraction search server 300 can arrange the detected popularity search term according to a predetermined sorting condition, and can expose it to a searcher who connected to each search server.

For this, the real-time popularity search term extraction search server 300 arranges the detected popularity search term according to the order of the magnitude of the first to the fourth determination value which is calculated, and can include the search term arrangement means 326 which generates a popularity search term list. That is, the search term arrangement means 326 generates the popularity search term list by endowing a higher class to the search term which is detected in priority as a popularity search term, and providing each search server with the popularity search term list such that the popularity search term list is exposed to a searcher connecting to each search server.

Particularly, the search term arrangement means 326 generates the popularity search term list at the period collecting the time interval log data described above in detail thereby, and the popularity search term list can be continuously renewed and exposed to a searcher. In addition, it can more rapidly deliver the information of the tendency of the search term input in the present time point is assimilated to a searcher. When a keyword is extracted through the search server 300 which extracts a keyword in the order of the real-time popularity search, the keyword corresponding to an event having the concerns of netizens of an online is extracted. Additionally, it is much probable that such keyword is much close to the information required in the communication through the e-mail of the client. Accordingly, it has the advantage that demand in the online e-mail service of a client can be considerably satisfied.

FIG. 8 is an embodiment of a second feature according to the present disclosure, and is an exemplary diagram showing the mail web window of a client applying the online email system.

As shown in FIG. 8, while a keyword is searched by automatically analyzing the morpheme of the mail contents in a search server, the client himself can directly input a search keyword through a search window displayed on a part of the area of the mail web window when the term relating to the information that a client wants is not searched. It is an e-mail service system in which detailed information is displayed when a keyword relating to the detailed information that a client wants to search is inputted through the search window, while the search server provides a search window to a part of the area of the mail web window.

That is, the search server displays the search window in a part of the area of the mail web window by using a general search browser, and matches the detailed information stored in the data server with the keyword inputted in the search window to display it in a part of the area of the client mail web window. This embodiment has the advantage that the keyword relating to the detailed information that a client wants is directly inputted to acquire the detailed information thereby, and the most suitable information can be obtained.

That is, although it automatically extracts a keyword, in case the keyword which is searched is not the keyword relating to the information that a client actually wants, the client is unable to get the desired information or the exact information corresponding to that. Therefore, through directly inputting by the client himself, an exact and convenient service can be provided to a client. It is preferable that the data server 200 storing the detailed information in the online e-mail service system exemplified in FIG. 8 is a data server which stores a data formed through the query and reply service by using the online network.

Further, in case the mail contents is a foreign language mail except the native language, it is also preferable that an example of the search server 300 of the online e-mail service system in FIG. 8 translate the keyword which the client received in the mail and inputted into the language which the client selected. In that way, the difficulty that a client grasps the meaning of an unfamiliar term which is a foreign language except the native language can be solved and the detailed information relating to this term can be obtained with the language selected by the client himself.

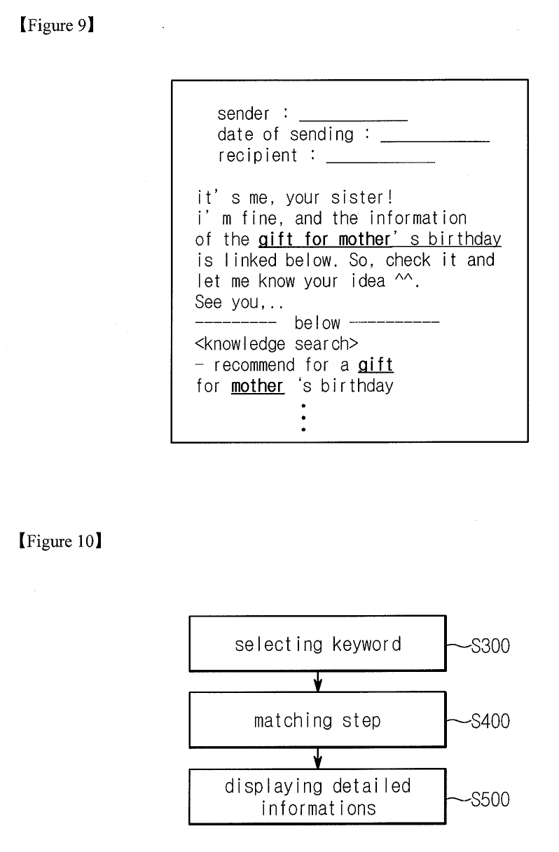

FIG. 9 is further embodiment of the present disclosure, and is an exemplary diagram showing the mail web window which is provided to e-mail transmitter in case the client that received the mail returns the reply mail.

As shown in FIG. 9, in case the reply mail for the received mail is sent by the client that acquired the detailed information through the online e-mail service system exemplified in FIG. 2 to FIG. 4 and FIG. 8, the obtained detailed information is automatically sent. In that way, the more convenient and useful e-mail communications tool can be provided. That is, the detailed information which the client acquired is automatically attached or inserted to the content of the reply and the inconvenience of separately collecting or attaching the detailed information can be eliminated. Here, it is selectable whether the detailed information is sent with the mail contents or not. Hereinafter, as a second feature of the invention, an embodiment of the online e-mail service method will be illustrated with reference to drawing.

FIG. 10 is a drawing exemplifying a brief flowchart of the mail reception step in the online service method according to the present disclosure.

As shown in FIG. 10, when the mail server receives the mail which is sent by the outside or other client and transmits it to the client, the client analyzes the morpheme of the mail contents received in the mail server in the step that the client receives the mail to select a keyword (S300).

The selected keyword is matched with the detailed information of the data server in which pieces of information are stored (S400). One or more pieces of matched detailed information are displayed in a part of the area of the mail web window of the client (S500).

That is, in the step that the client receives the mail, the keyword relating to the detailed information that the client requires is automatically selected (S300), and matched with the detailed information stored in the data server (S400), thereby, the most proper detailed information is provided on a part of the area of the client web window with the mail contents (S500). Accordingly, the service method for providing a convenient online e-mail communications tool can be provided.

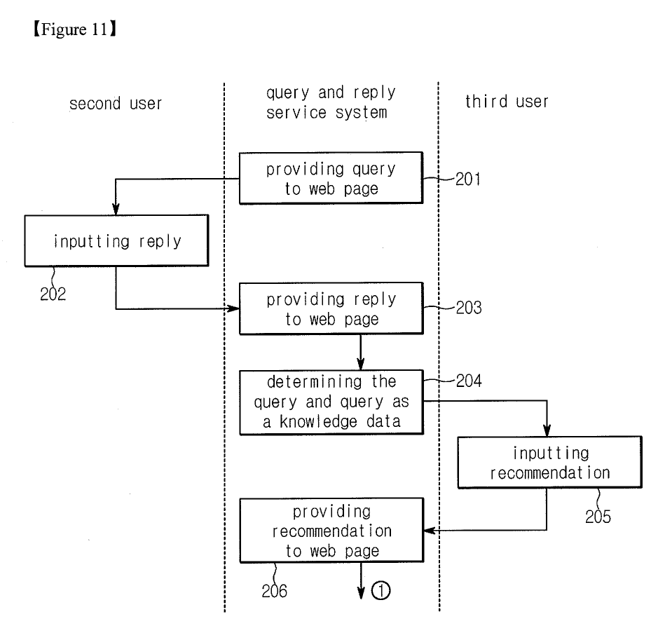

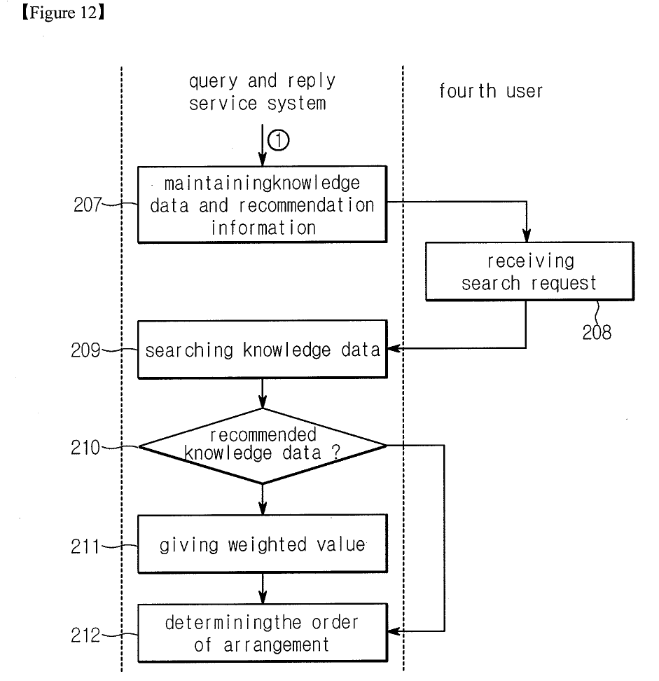

FIGS. 11 and 12 are the drawing exemplifying a logical flow chart of the query and reply system as data server used in the online e-mail service method according to the present disclosure.

As shown in FIGS. 11 and 12, the online e-mail service is provided by utilizing the data server in which the data formed through the query and reply service system is stored. Hereinafter, embodiments of the method for extracting the knowledge data in the query and reply service system will be illustrated in more detail.

Firstly, in the step 201 of providing the query, the query inputted from a first user is provided to a predetermined web page. In the reply input step 202, a reply is inputted from a second user during a predetermined period for the query. In the step 203 of providing a reply to the web page, a reply relating with the query is provided to the web page. In the step of 204 determining a knowledge data, the query and the query related to the reply are determined as a knowledge data, or in case the input of reply and the accept of reply are completed, that is, in the state where the query is no more exist and the reply is not changed, they are determined as a knowledge data.

Further, in the recommendation input step 205, the recommendation for the knowledge data is inputted from a third user, or it is determines whether the third user is identical with the first user inputting the query and the second user inputting the reply. In case they are not identical, the recommendation is inputted. In that way, the objectivity of the recommendation can be secured. In addition, in the recommendation providing step 206, the recommendation related with the knowledge data is provided to the web page.

According to another embodiment of the present disclosure, the knowledge data to which the recommendation is inputted is displayed by a predetermined display method in order to be distinguished from other knowledge data. As to the knowledge data in which the recommendation is inputted, the letter or the color of the background, the size of the letter can be differently displayed, or it can be displayed with a display method that a predetermined icon is additionally displayed. Therefore, it is comfortable for the user to peruse the knowledge data since the knowledge data in which the recommendation is inputted can be easily recognized.

Additionally, according to another embodiment of the present disclosure, the recommendation input step 205 includes the step that the category related to the knowledge data is inputted from the third user, and the recommendation providing step 206 includes the step that the category is displayed in relation to the knowledge data. Therefore, the user who wants to receive the knowledge related to the category can easily peruse the knowledge data which are related and recommended to the category by using the category displayed on the web page. Thereafter, in the step 207, the query and reply service system maintains the knowledge data and the recommendation information related to the knowledge data in the knowledge database. The recommendation information is information of whether the recommendation for the knowledge data was inputted or not.

When the query and reply service system receives a search request for the knowledge data from a fourth user in the step 208, it searches the knowledge data in the knowledge data base in response to the search request in the step 209. At this time, in case a plurality of knowledge data are searched as a result of the search, it is determined whether the knowledge data which is searched based on the recommendation information is a knowledge data or not in the step 210. A predetermined weighted value is given to the recommended knowledge data to determine the order of the arrangement of the knowledge data (step 211 and 212).

Accordingly, in addition to the degree of the accordance of knowledge data for the search keyword, the recommendation can be another element that determines the order of the arrangement. Therefore, the online service method provides the configuration in which the keyword extracted from the mail contents which the client received is matched with the detailed information which is stored in the data server, by utilizing the data server in which the knowledge data which is formed by using such query and reply service system is stored, thereafter, the matched detailed information is displayed on a part of the area of the client mail web window.

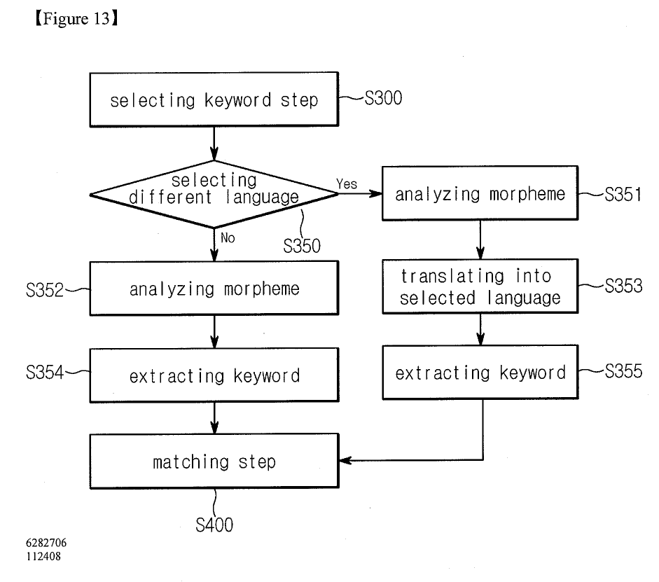

FIG. 13 is an embodiment according to the present disclosure, is a drawing showing a flowchart of the method which is applied in case detailed information is acquired with a language which is different from the other language of the mail contents received in the keyword selection step.

As to FIG. 13, in case the client receives the foreign language mail except the native language such as Korean mail, occasionally, the detailed information of the native language is required. That is, in case the detailed information is acquired with the other language different from the language of the mail contents that the client is received, FIG. 13 exemplifies the method for extracting the keyword in the keyword selection step as an online e-mail service method. In the keyword selection step, when the language different from the language of the mail contents that the client received is selected (S350 Yes), the morpheme of the e-mail content is analyzed (S351), and it is translated into the selected language according to the morpheme (S353). The keyword is extracted through the translated keyword (S355), and it is matched with the detailed information of the data server (S400). Of course, in case the language different from the language of the mail contents is not selected (S350 No), the morpheme is directly analyzed (S352), and the keyword is extracted (S354), and the extracted keyword is matched with the detailed information of the data server (S400) to display it on a part of the area of the client mail web window.

As a further embodiment according to the present disclosure, it is preferable that the keyword selection step extracts a keyword in the order of the real-time popularity search. That is, the popularity search ranking is determined by the statistics that the online internet users analyze the search term. As to the online e-mail service method of the present disclosure, the keyword is selected based on the search ranking, and the selected keyword is matched with the detailed information of the data server to provide the matched detailed information for the client.

Such popularity search term is variable and can be changed in every hour. Thus, it is preferable that the popularity search ranking is a real-time data. In this way, the online e-mail service users can readily acquire the detailed information related to the keyword which recently becomes an issue among the mail contents. Accordingly, it can meet the demand of the service user. Here, the method for determining the real-time popularity search ranking can be variously applied, and it is needless to be a search ranking data extracted from a specific one server. Furthermore, the embodiment of the disclosure can be implemented in the form of a program instruction which can be performed through the computer facility to be recorded in a computer-readable medium.

Here, the computer-readable medium can include a program instruction, a data file, a data structure independently or by assembling them. The program instruction recorded in this media can be specially designed or configured for the present disclosure, or can be a usable thing which is known to the person who is skilled in the art of the computer software. The example of the computer readable recording medium includes a hard disk, a magnetic media such as a floppy disk, a magnetic tape, an optical media such as CD-ROM, DVD, a magneto-optical media such as a optical disk, and a hardware device including ROM, the RAM, the flash memory, which is specially made in order to store and perform a program instruction.

Further, this media can be a transmission media such as a light, a metal line, and a waveguide including a carrier wave transmitting the signal designating a program instruction, and a data structure. The example of the program instruction includes a high level language code which can be performed through a computer by using an interpreter as well as a machine code made with a compiler. The above-described hardware device can be operated as one or more software modules in order to perform the operation of some embodiments of the present invention, and vice versa.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

### INDUSTRIAL APPLICABILITY

According to the present disclosure, in case the online e-mail service system and method is provided, in communications of online mail, the detailed information relating to the mail contents can be easily and rapidly obtained, and the e-mail communications tool which can rapidly return the content of the detailed information which is queried on the mail to the inquirer is provided.

What is claimed is:

1. A method of providing information that accompanies an email from a first user based on content of the email that is uncommon, wherein the email is sent through an email service having a plurality of users, said method comprising:
receiving, from a first user, an email comprising words in a first language;
extracting keywords from the email based on morphemes of the words in the email and respective frequencies of the words used by a plurality of other users of the email service;
obtaining a set of search results from at least one search server that is accessible to the email service based on the extracted keywords; and
providing at least some of the results and information indicating respective locations of the results with the email.

2. The method of claim 1, wherein receiving an email comprises receiving a web-mail email.

3. The method of claim 1, wherein extracting keywords comprises extracting keywords with a low frequency of use.

4. The method of claim 3, wherein extracting keywords comprises extracting keywords with the lowest frequency of use.

5. The method of claim 1, wherein extracting keywords wherein the frequencies of use are based on popularity of searches by the plurality of users.

6. The method of claim 1, wherein providing at least some of the results comprises providing at least some of the results as selectable links, that, when selected, navigate a user receiving the email to network location of the respective results.

7. The method of claim 1, wherein providing at least some of the results comprises providing at least some of the results in a second language.

8. The method of claim 1, wherein providing at least some of the results comprises providing at least some of the results in a webpage provided to a user receiving the email.

9. The method of claim 1, further comprising automatically replying to the first user of the email with another email that includes the results.

10. A method of providing information that accompanies an email from a first user based on content of the email that is uncommon, wherein the email is sent through an email service having a plurality of users, said method comprising:
receiving, from a first user, an email comprising words in a first language;
extracting keywords from the email based on morphemes of the words in the email and respective frequencies of the words used by a plurality of other users of the email service; and
providing a search window for searching at least one search server that is accessible to the email service with the email.

11. A method of receiving information that accompanies an email from a first user based on content of the email that is uncommon, wherein the email is received through an email service having a plurality of users, said method comprising:
sending, from a first user, an email comprising words in a first language;
extracting keywords from the email based on morphemes of the words in the email and respective frequencies of the words used by a plurality of other users of the email service;
obtaining a set of search results from at least one search server that is accessible to the email service based on the extracted keywords; and
receiving at least some of the results and information indicating respective locations of the results with the email.

12. The method of claim 11, wherein sending an email comprises sending a web-mail email.

13. The method of claim 11, wherein extracting keywords comprises extracting keywords with a low frequency of use.

14. The method of claim 13, wherein extracting keywords comprises extracting keywords with the lowest frequency of use.

15. The method of claim 11, wherein extracting keywords wherein the frequencies of use are based on popularity of searches by the plurality of users.

16. The method of claim 11, wherein receiving at least some of the results comprises receiving at least some of the results as selectable links that, when selected, navigate a user receiving the email to network location of the respective results.

17. The method of claim 11, wherein receiving at least some of the results comprises receiving at least some of the results in a second language.

18. The method of claim 11, wherein receiving at least some of the results comprises receiving at least some of the results in a webpage provided to a user receiving the email.

19. The method of claim 11, further comprising automatically replying to the first user of the email with another email that includes the results.
